(19) United States
(12) Patent Application Publication
(10) Pub. No.: US 2009/0056220 A1
(43) Pub. Date: Mar. 5, 2009

(54) GROWING CONTAINERS

(76) Inventors: Frank DIPAOLO, Scranton, PA (US); Matthew Markefka, Richboro, PA (US); Clifford Fay, Harveys Lake, PA (US)

Correspondence Address: STITES & HARBISON PLLC, 1199 NORTH FAIRFAX STREET, SUITE 900, ALEXANDRIA, VA, 22314, US

(21) Appl. No.: 11/948,371

(22) Filed: Nov. 30, 2007

Related U.S. Application Data
(63) Continuation of application No. 11/741,309, filed on Apr. 27, 2007, now abandoned.
(60) Provisional application No. 60/861,738, filed on Nov. 30, 2006.
(60) Provisional application No. 60/796,201, filed on May 1, 2006.

(51) Int. Cl. A01G 25/00

(52) U.S. Cl. 47/79

(57) ABSTRACT

A growing apparatus in which a plant is grown includes a container having a bottom and a surrounding wall member attached to the bottom, and a perforated partition located in the container above the bottom to define a water reservoir space. The container further includes a plurality of holders extending upwardly from the bottom and attached to the surrounding wall. Each holder includes a first portion which vertically engages the perforated partition to hold the partition a predetermined distance above the bottom, and a second portion which horizontally engages the perforated partition to hold the surrounding wall member adjacent the partition. The perforated partition further includes a planar base and a skirt depending from the base, whereby the skirt is engaged by the first portion and the second portion of the container. The apparatus has various cover elements to be placed over a plant growing medium which in use is filled in above the perforated partition.

### CROSS REFERENCE TO RELATED APPLICATIONS

This Application is related to and claims the benefit of Provisional Application Ser. No. 60/796,201, filed May 1, 2006, Provisional Application Ser. No. 60/861,738, filed Nov. 30, 2006, and U.S. application Ser. No. 11/741,309, filed Apr. 27, 2007, all of which are incorporated herein by reference.

### BACKGROUND OF THE INVENTION

The present application relates to constructions useful in an existing, commercially-available product known as a self-watering planter sold under the trademark EARTHBOX®, or the like-planter. The EARTHBOX® trademark is the subject of U.S. Reg. No. 1,906,561. The EARTHBOX® self-watering planter container relates to one or more of several U.S. patents granted to Blake Whisenant, namely, U.S. Pat. Nos. 5,103,584; 5,193,306; 5,379,547; 5,524,387; 5,555,675, which are incorporated herein by reference.

The EARTHBOX® growing container typically includes, among other things, a planting container, a perforated partition spaced from the bottom of the container, and a water overflow means to control the water level below the perforated partition when in use. Additionally, the EARTHBOX® self-watering planter (after being provided with growing medium and nutrients in the upper portion of the container above the partition), is covered by an element also known as “plastic mulch” or described as a sheet, top or cover to protect the nutrients from degradation by the environment such as rain or the like. The existing EARTHBOX® planter uses a flexible replaceable cover which has an elasticized periphery to fit down over the outer upper edge of the planting container.

### BRIEF SUMMARY OF THE INVENTION

In accordance with the present invention, a growing apparatus in which a plant is grown includes a container having a bottom and a surrounding wall member attached to the bottom, and a perforated partition located in the container above the bottom. The container is preferably rectangular further includes a plurality of holders extending upwardly from the bottom and is attached to the surrounding wall. Each holder includes a first portion which vertically engages the perforated partition to hold the partition a predetermined distance above the bottom, and a second portion which horizontally engages the perforated partition to hold the surrounding wall member adjacent the partition. The perforated partition is likewise preferably rectangular and further includes a planar base and a skirt depending from the base, whereby the skirt is engaged by the first portion and by the second portion of the container.

In a preferred embodiment, the perforated partition includes a series of reinforcing bosses extending between the skirt and the planar base. These reinforcing bosses strengthen the perforated partition vertically as well as horizontally. In addition, the perforated partition includes a reinforcing rib extending between opposed sides of the skirt. This reinforcing rib strengthens the perforated partition vertically as well as horizontally. More preferably, the perforated partition includes at least two of the reinforcing ribs which meet at an intersection; and then the container includes a support upstanding from the bottom which engages the reinforcing ribs at the intersection to vertically support the perforated partition at the intersection.

Other features and advantages of the present invention are stated in or apparent from detailed descriptions of presently preferred embodiments of the invention found herein below.

### BRIEF DESCRIPTION OF THE SEVERAL VIEWS OF THE DRAWINGS

FIG. 1 is a side elevation view of an apparatus including a growing container with a staking system attached according to the present invention.

FIG. 2 is an end elevation view of the apparatus depicted in FIG. 1.

FIG. 3 is an isometric top, end and side view showing the interior of the growing container depicted in FIG. 1 without the growing medium plants, etc.; and in particular it depicts the outer growing container with the perforated partition spaced vertically from the bottom of the container.

FIG. 4 is an isometric top, end and side exploded view of a portion of the container and one outrigger as depicted in FIG. 1.

FIG. 5 is an isometric bottom, side and end exploded view of the container and outrigger as depicted in FIG. 4.

FIG. 6 is an exploded and enlarged isometric bottom, end and side view depicting a rim clamp and a portion of a vertical stake used for attachment to the rim of the container.

FIG. 7 is an enlarged isometric bottom, side and end view with portions cut away depicting the inter-engagement means between the perforated partition and the inside of the bottom and sides of the container.

FIG. 8 is an isometric bottom, end and side view of the perforated partition depicting the strengthening webs and gussets molded into the partition.

FIG. 9 is an isometric top, end and side view of the perforated partition of FIG. 8.

FIG. 10 is an isometric top, end and side view showing the interior of the growing container depicted in FIG. 3 and without the perforated partition.

FIG. 11 is a partial isometric view showing one end of an EARTHBOX® growing container and depicts a cover element according to one embodiment of the present invention.

FIG. 12 is a partial view of the cover element depicted in FIG. 11.

FIG. 13 is a plan view of another embodiment of a cover element for use with a growing container.

FIG. 14 depicts still another embodiment of a cover element arranged on top of the growing medium situated within the confines of the growing container.

FIG. 15 is an isometric view showing still another embodiment of the cover element for use in a growing container.

FIG. 16 depicts another embodiment of a cover element in an isometric view that shows wire structure for insertion into the corner regions of the growing medium in a growing container.

FIG. 17 is still another isometric view of a modification of the wire depicted as part of FIG. 16.

FIG. 18 is an isometric view schematically showing a growing container with one embodiment of the cover element in an open and covering relationship.

FIG. 19 is an isometric view of another embodiment of the cover element wherein clip means are provided at the corner of the cover element and the clip means are engageable with the corner portions of the growing container. Furthermore, FIG. 19 depicts a nipple attached to the overflow element of the growing container whereby a tube or other conduit may be attached.

FIG. 20 is an isometric view of a growing container on a structure for supporting the container above a floor or the like.

FIG. 21 is an isometric view of another embodiment of a cover element for a growing container wherein upper and lower sheets of covering material are utilized and are connected at two places along the axis of the cover for holding plant nutrients.

FIG. 22 is a isometric view showing a schematically growing container with still another form of cover element wherein plant locations are depicted by perforated circular areas.

FIG. 23 is a further detailed diagram of one embodiment of cover element utilized in the manner depicted in FIG. 12.

FIG. 24 is a partial isometric view of a cross section of a growing container depicting a design for a nutrient container including anchoring means for said container as arranged on the upper surface of growing medium shown in phantom lines.

FIG. 25 is still another embodiment of a containing structure for the nutrient material.

### DETAILED DESCRIPTION OF THE INVENTION

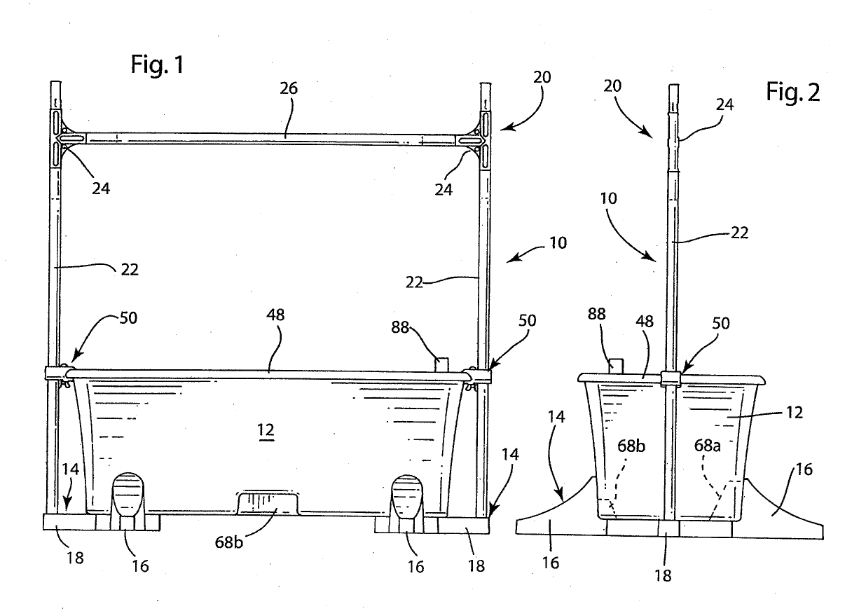

With reference now to the drawings in which like numerals represent like elements, FIGS. 1 and 2 depict a growing apparatus 10 in accordance with the present invention. Growing apparatus 10 includes an Earthbox® type container 12, which is depicted as a truncated rectangular structure and which has been formed by an integral blow molding or the like. As shown in the Whisenant patents noted above, container 12 holds, above a partition beneath which a reservoir is formed, a growing medium and fertilizer for growing plants such as tomato plants, green peppers, etc.

At the outer lower ends container 12 there is a staking system 20 which includes a pair of outriggers 14. As best seen in FIGS. 1-2 and 4-6, each outrigger 14 is configured to have lateral feet 16 that extend outward from the side of the container 12 and a longitudinal foot 18 that extends outward from the end along the longitudinal axis of the container 12. The purpose of the outriggers 14 are to provide additional stability to the planted container 12; and additionally to provide a support function for a remainder of staking system 20 which includes two vertical stakes 22, two connectors 24 and a horizontal interconnecting stable bar or element 26 as depicted in FIGS. 1 and 2. As shown, the bottom of vertical stake 22 is received in and extends upwards from a hole 28 having a closed bottom end which is provided in the free end of each respective longitudinal foot 18.

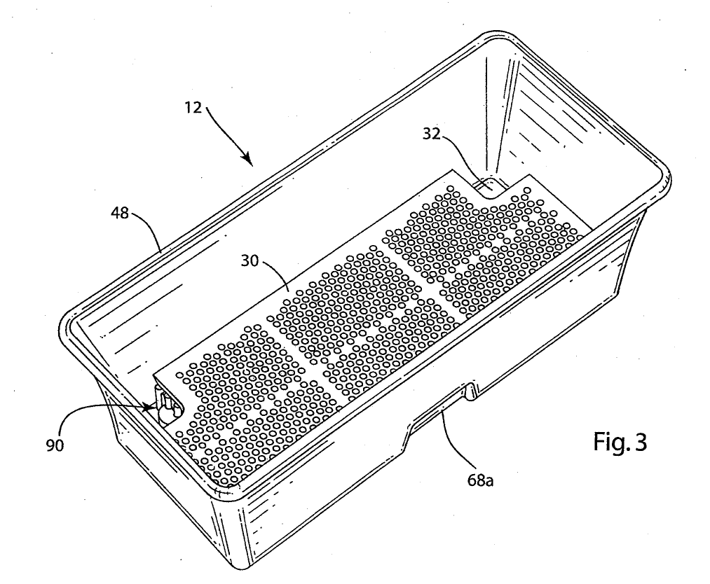

FIG. 3 depicts the arrangement of the perforated partition 30 within the lower portion of the container 12. As depicted, the opposite ends of the partition have cut-outs 32. When growing apparatus 10 is assembled, the growing medium (not shown) is placed on top of partition 30 and additionally in the cut-outs 30 at the corners of the container 12 down to the bottom of container 12. Thus, the growing medium in the cut-outs 32 provide a wicking function for water, located in the lower reservoir portion 82 of the container 12 below the perforated partition 30, to the growing medium located above partition 30 and mostly otherwise filling container 12.

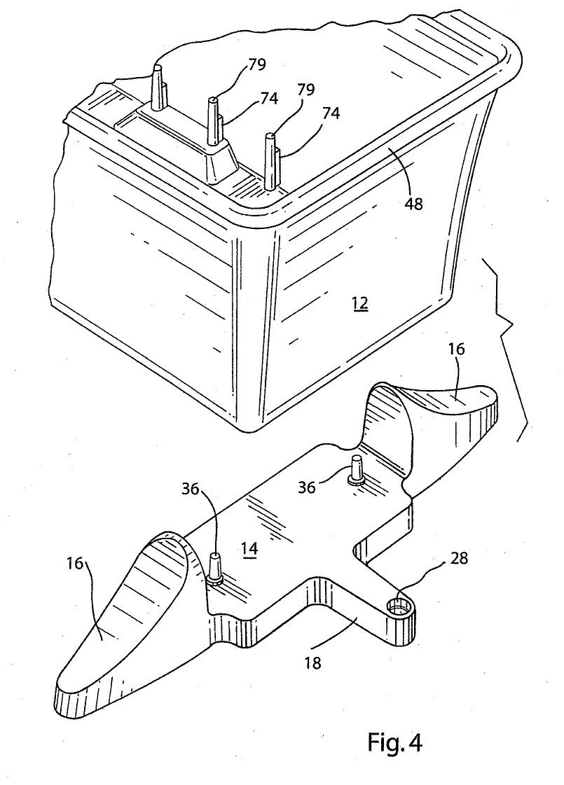

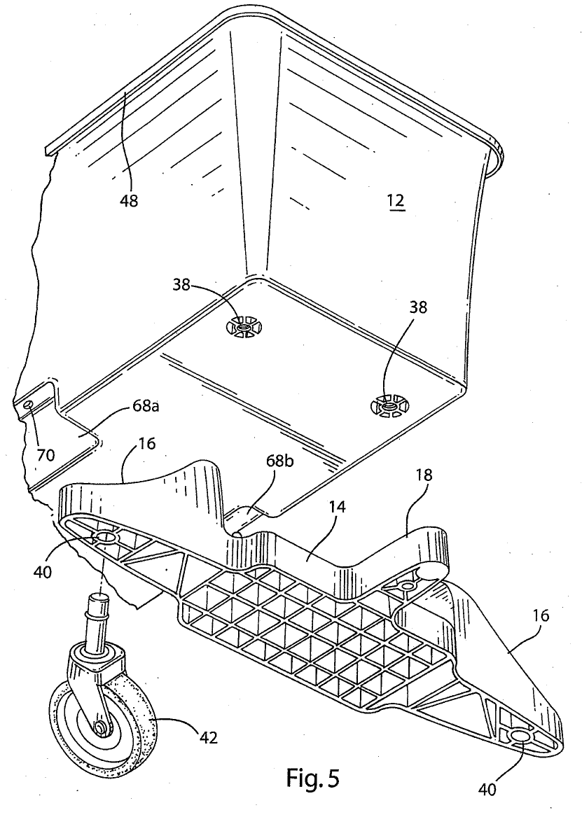

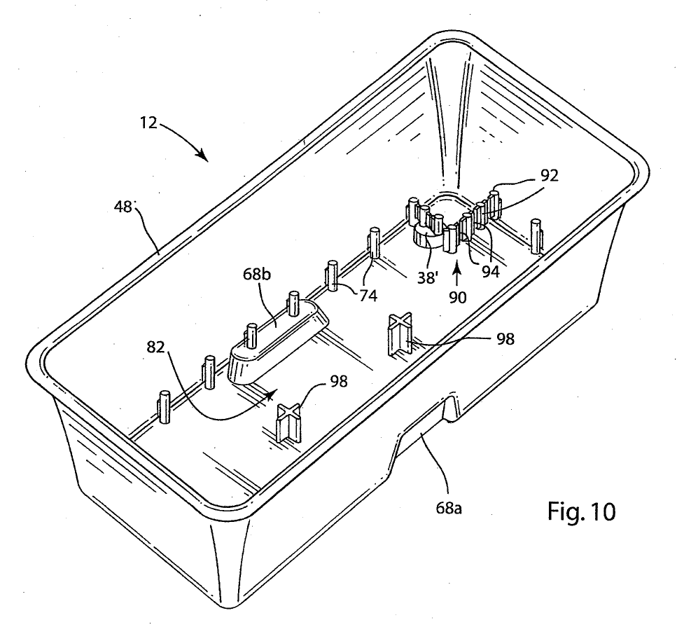

As seen in FIG. 4, each outrigger 14 is provided with vertically oriented pins 36 that engage with and into the bottom of the container 12. As further depicted in the exploded view of FIG. 5, spaced pin receiving holes 38 which are closed (see FIG. 10) are integrally molded in the horizontal base of the container 12 to receive respective pins 36. When viewed from above as in FIG. 10, closed holes 38 appear as an upstanding cylinder 38′ as shown in the one corner, which cylinder 38′ in this case is also formed with other elements as discussed below. Also, as depicted most clearly in FIG. 5, the lateral feet 16 of each outrigger 14 have bushings or defined holes 40 into which the vertical pins of respective casters or other wheels 42 may be inserted to provide mobility for moving a planted growing apparatus 10 around. Such ease of mobility is an advantage in that the entire growing apparatus 10 can be moved from one place to another as desired such as might be desired due to weather changes, the position of the sun during the afternoon, etc. Furthermore, the use of caster wheels 42 makes it much more easier to move the container 12 when completely planted because the container 12 when planted contains water and growing medium of substantial weight. If desired, a caster pin hole can also be provided at the end of longitudinal foot 18 extending up through closed hole 28 as well to add two additional castor wheels to additionally help support the weight and/or mobility of growing apparatus 10. Alternatively, the pins of the caster wheels can be inserted directly in closed holes 38 is staking system 20 is not used or not currently being used.

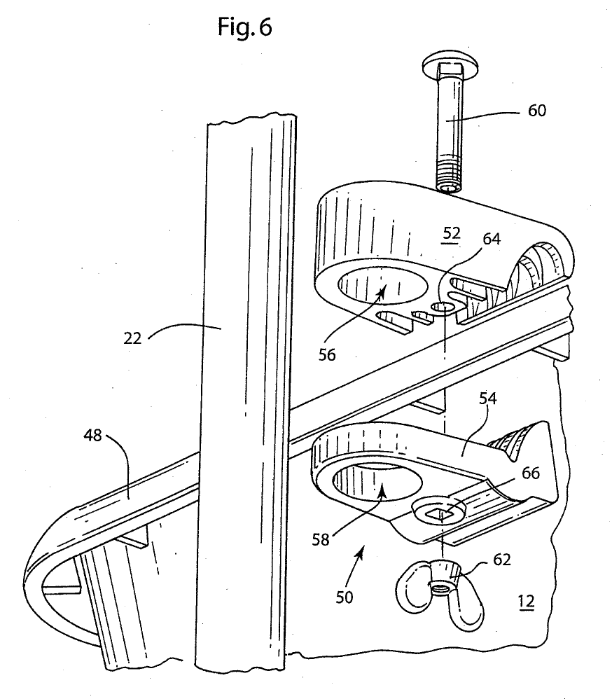

As also depicted in FIGS. 1 and 2, vertical stakes 22 are reinforced or held securely at the level of the rim 48 of the container 12 through the use of a rim clamp 50. As depicted in the exploded view in FIG. 6, the rim clamp 50 includes an upper clamp element 52 and a bottom clamp element 54 which inter-engage. When inter-engaged, both elements 52, 54 define aligned holes 56 and 58 through which the vertical stake is inserted during assembly of the staking system 20. As depicted in FIGS. 1 and 2, when completely assembled, upper rim clamp 52 and bottom rim clamp 54 are engaged and held tightly together by means of a carriage bolt 60 and a wing nut 62 passing therethrough in respective holes 64 and 66—both of which have a square end as depicted for hole 64 so bolt 60 can be inserted into either element 52 or 54. Clamp elements 52 and 54 are obviously secured over and under the overturned rim 48 of container 12 so that when wing nut 62 is tightened rim clamp 50 is thus rigidly attached to container 12.

FIG. 5 also depicts the arrangement of the bottom portion of the container 12 which utilizes concave indentations 68a and 68b at the longitudinal center of each intersection of the side and bottom. In horizontally larger (as shown best in phantom in FIG. 2) indentation 68a, a water overflow opening 70 is formed. Overflow opening 70 is simply a vertical hole and is used for easy water drainage whenever the height of water in container 12 is temporarily above opening 70 as sometime occurs when the reservoir 82 (discussed below) is overfilled inadvertently (or purposefully, to bring the water level up to its maximum desired height). Opening 70 is resistant to blockage, as anything tending to block the opening 70 which is smaller than opening 70 is pulled by gravity through opening 70. It will also be noted that the other, smaller concave indentation 68b is provided for aesthetics and symmetry.

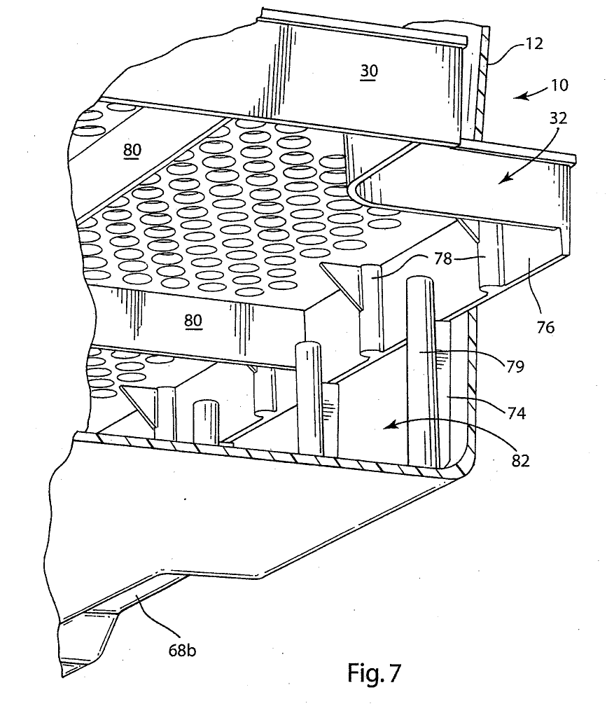

FIG. 7 shows a partial cut-away view of the longitudinal corner of the perforated partition 30 engaging the lower interior portion of the container 12. FIG. 7 also shows that integral, vertically gusseted bosses or holders 74 are located somewhat spaced from the outer wall of the container 12 so as to provide an inter-engagement means for partition 30. In particular, this engagement means is in the form of a free end 79 for the depending skirt 76 formed around the outer periphery of the perforated partition 30. Also the perforated partition 30 has integral strengthening gusseted bosses 78 as well as integral webs or ribs 80 running across and lengthwise along the bottom of the perforated partition 30. Bosses 78 and ribs 80 provide strength so that the perforated partition can support the vertical weight of a growing medium and plants and other items which are utilized to grow plants. Bosses 78 and ribs 80 also provide horizontal strength so that when skirt 76 is trapped behind free end 79 of holders 74 of container 12, the sidewalls of container 12 will not bow out under the pressure/weight of the growing medium and water contained in container 12 during use. It will be appreciated that the area in FIG. 7 located below the perforated partition 30 and above the horizontal bottom of the growing container 12 is the water reservoir 82 where water is held during use, but only up to a certain maximum level depending upon the vertical location of the water overflow opening 70 as shown in FIG. 5 and discussed above.

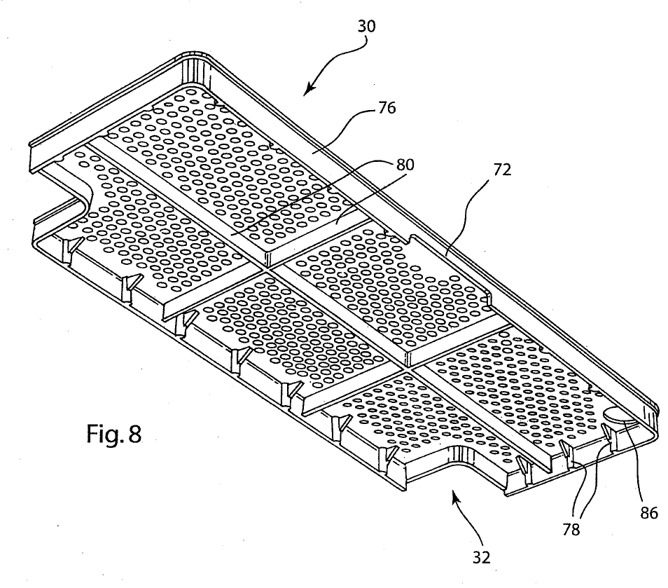

FIG. 8 is an isomeric view of the bottom of the perforated partition 30 showing its outer skirt 76 as well as the sideways and lengthways support webs or ribs 80 in addition to integral gusseted bosses 78 which are arranged around the inner and lower periphery of the perforated partition 30. Also depicted are the cut-out corners 32 as well as a hole 86 in the most right hand corner of FIG. 8 for allowing a water filler pipe 88 to be inserted through the partition 30 into the lower water reservoir 82 of an assembled container 12.

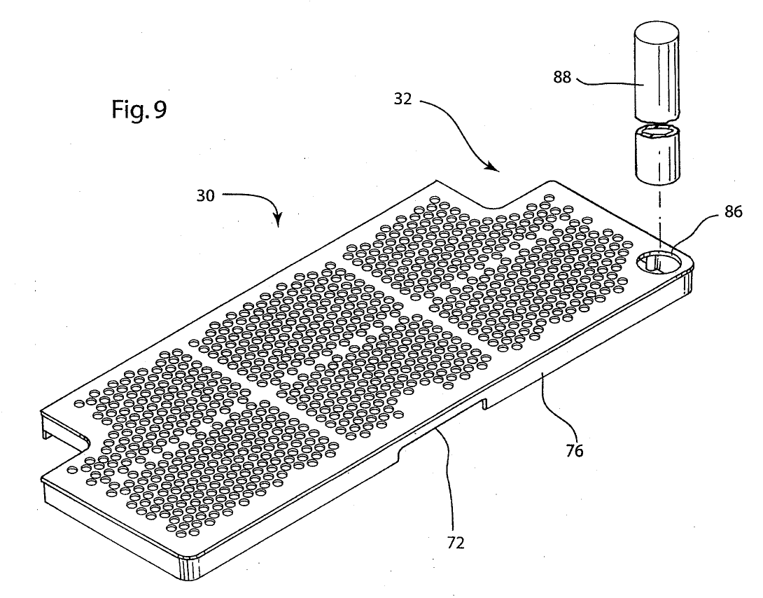

FIG. 9 is an isometric view depicting the top of the perforated partition 30 and showing the circular hole 86 in the corner and the cut-out corners 32 provided in at least one corner of the perforated partition 30. The tube 88 or the like is snuggly received in hole 86 before the growing medium is added and extends above rim 48. After the growing medium is added and growing of plants commences, water for the plants is easily poured down tube 88 and into reservoir 82 when/as needed; and as often as desired without fear of over-watering since any excess water will drain out of water overflow opening 70. It will be noted that perforated partition 30 has no perforations immediately above and around overflow opening 70, and a cut-out 72 in skirt 76 facilitates drainage through overflow opening 70.

Depicted in FIG. 10 is a perspective view of the bottom of container 12 showing a dam structure 90 provided below where the cut-out 32 of perforated partition 30 is located (at both ends). Dam structure 90 is formed of upstanding pillars 92 with vertical flanges 94 extending therefrom toward adjacent pillars 92; and at the location of cylinder 38′, pillars 92 and flanges 94 are formed integrally therewith above cylinder 38′. The flanges 94 do not touch or meet, but instead provide a small vertical passage. In addition, it will be appreciated that skirt 76 is raised (does not extend as low) at the location of cut-out 32, while pillars 92 are shorter than holders 74. Thus, during use, water is easily transported over and around pillars 92 and flanges 94 into the growing medium deposited in cut-out 32 when reservoir 82 has water therein, but the coarser growing medium is largely dammed up behind dam structure 90 during use.

FIG. 10 also depicts upstanding supports 98 extending from the bottom of container 12. Supports 98 are located at the intersections of ribs 80, and extend up to the intersections. Supports 98 thus vertically support ribs 80 and hence perforated partition 30 at these locations to help prevent a downward bowing of perforated partition 30 during use.

It should be apparent that the improvements depicted provide for ease of manufacture and use of the disclosed growing apparatus 10. For example, the container 12 itself may be injection molded so as to integrally form the rim 48, the water overflow opening 70 and the openings or holes 38 for outrigger 14 or castors 42. Furthermore, it should be apparent that the perforated partition 30 may be injection molded to provide a strengthened horizontal base for supporting the growing medium, the fertilizer and the plants among other elements when the growing apparatus 10 is completely assembled and operational.

In addition, it should be apparent that the design of the container 12 itself is aesthetically pleasing and that the design of the rim clamp is more aesthetically pleasing than the flexible ties utilized in the prior art for tying vertical wooden stakes to the interior of prior EARTHBOX® containers.

FIG. 11 depicts the arrangement of the EARTHBOX® growing container designated as 101 including a container 102, a cover sheet 103, and wires 104 having an end configuration for insertion in hole 105 molded in the top edge of container 102. It should be understood that a wire 104 extends along substantially the entire length of the growing container and one is positioned on each lateral side of the cover sheet. FIG. 12 depicts one specific end design for wire 104 according to one embodiment of the cover sheet 103.

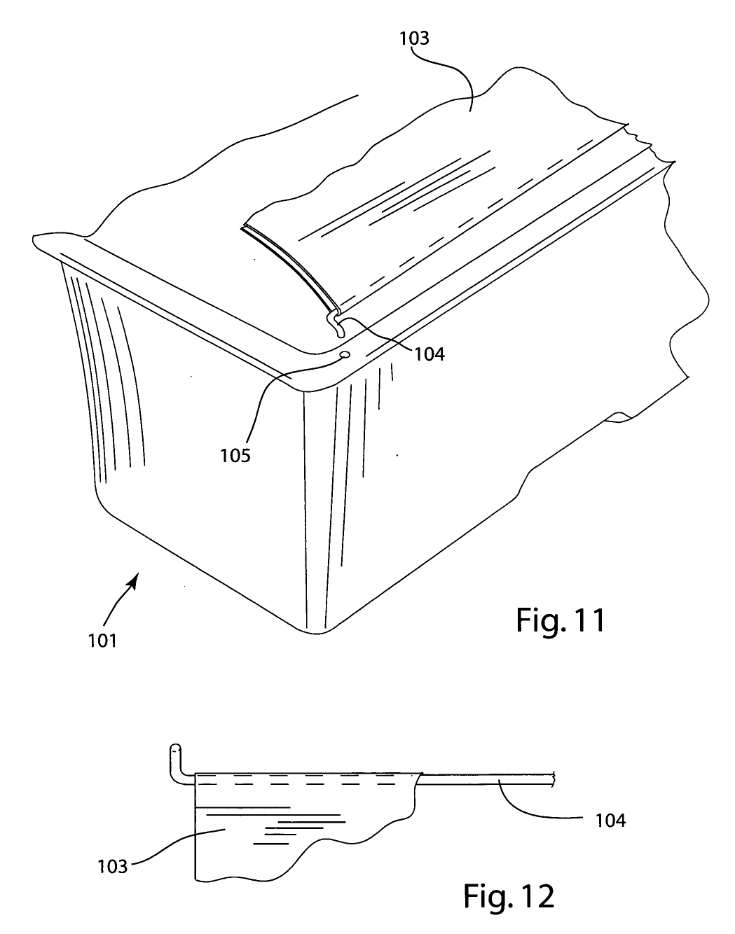

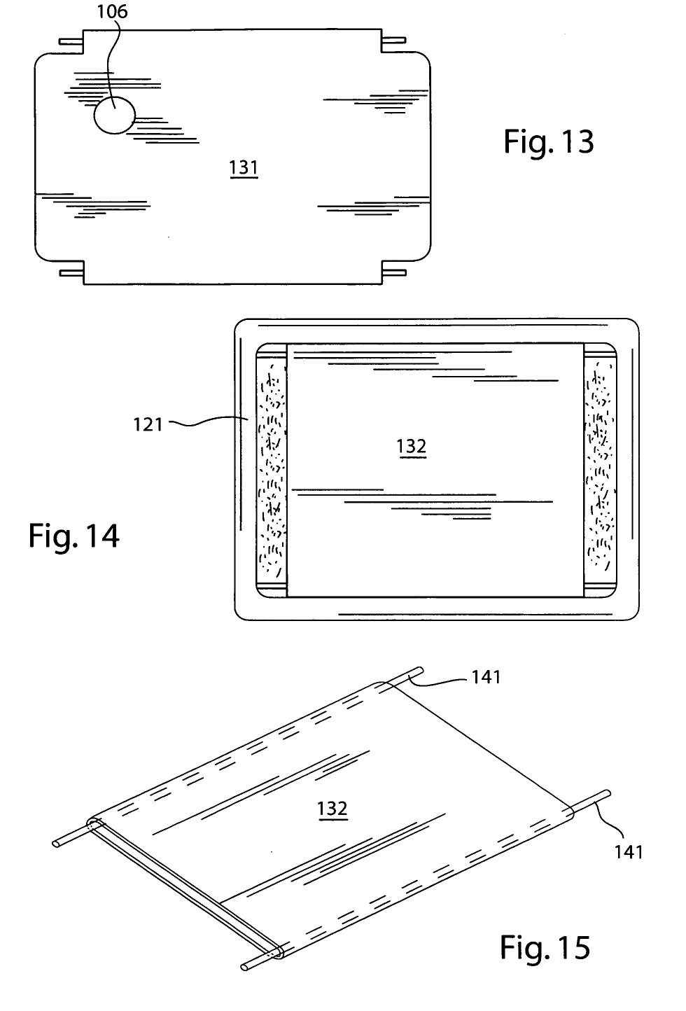

FIG. 13 depicts a plan view of still another embodiment of cover sheet 131 wherein the cover sheet has been modified by cutouts in each of its four corners as well as being provided with a opening 106 for the insertion of a plant, for evaporation, for a water fill tube typically used in a EARTHBOX® brand growing container, or the like.

FIG. 14 is a plan view of a planting container 121 with an associated cover sheet 132 for substantially covering the growing medium enclosed within the periphery of container 121.

FIG. 15 is a depiction of another embodiment of the cover sheet made from a tubular sheet of plastic designated as 132 and having linear wires 141 inserted in each folded edge of the cover sheet.

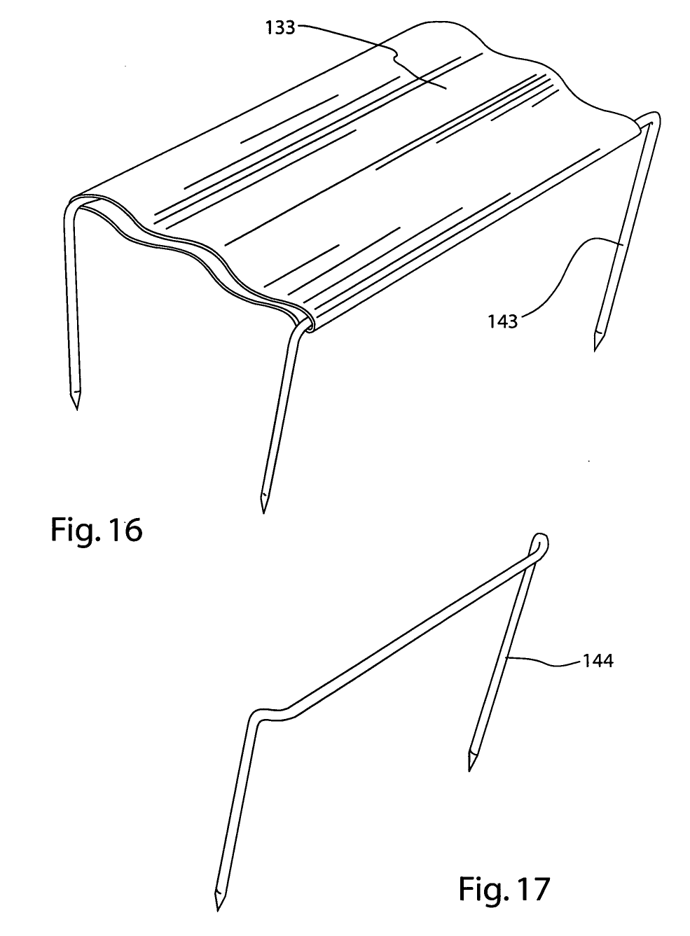

FIG. 16 depicts another embodiment of a cover sheet 133 wherein the wires 143 have downwardly projecting portions located in the corners of the cover sheet so that these downwardly directed portions can be inserted into the upper surface of the growing medium contained within the growing container to securely hold the cover sheet over the growing medium and fertilizer of the growing container.

FIG. 17 is still another embodiment of the wire utilized in, for example FIG. 16, wherein an additional bend called “around the corner” is provided to cooperate with the shape of the container. Otherwise, the vertical portions of wire 144 serves the same function as wire 143 in FIG. 16.

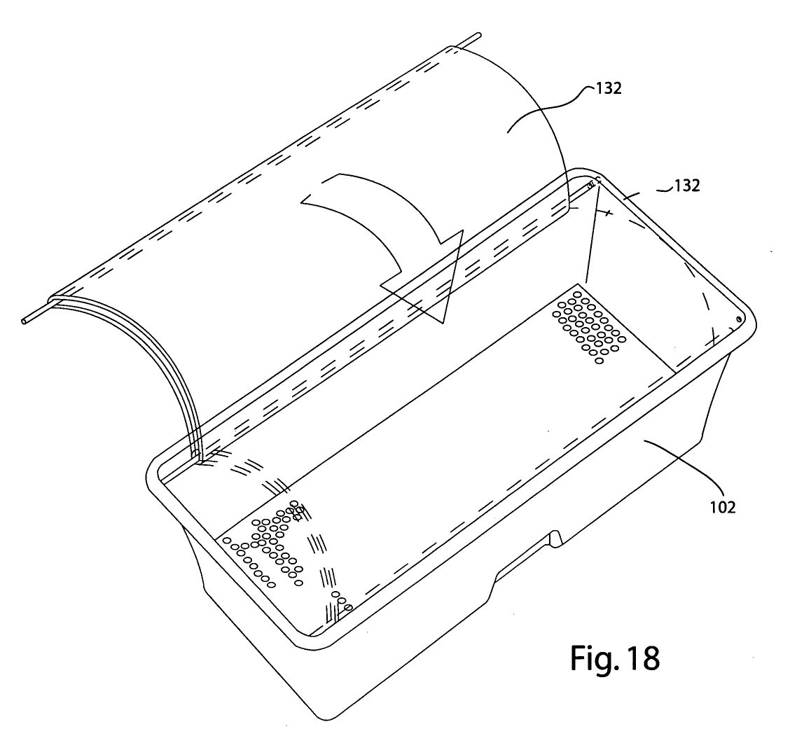

FIG. 18 is a isometric view showing a growing container 102 in diagrammatic form whereby the cover sheet, including its linear wire inserts such as shown in FIG. 5, is associated with the remainder of the growing container. FIG. 18, shows cover sheet 132 in an open position to the left and a closed position over the growing medium area of the container when moved in the direction of the arrow.

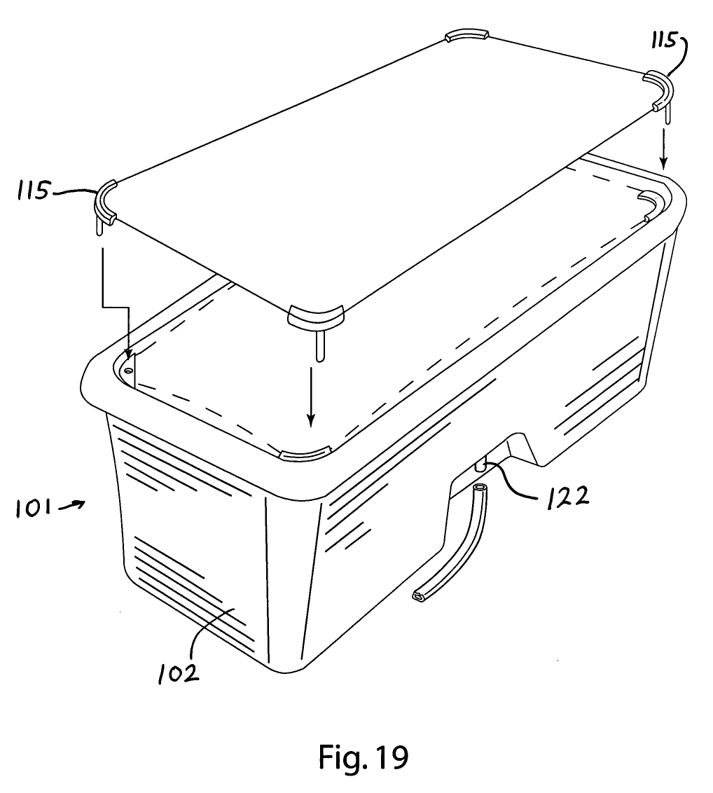

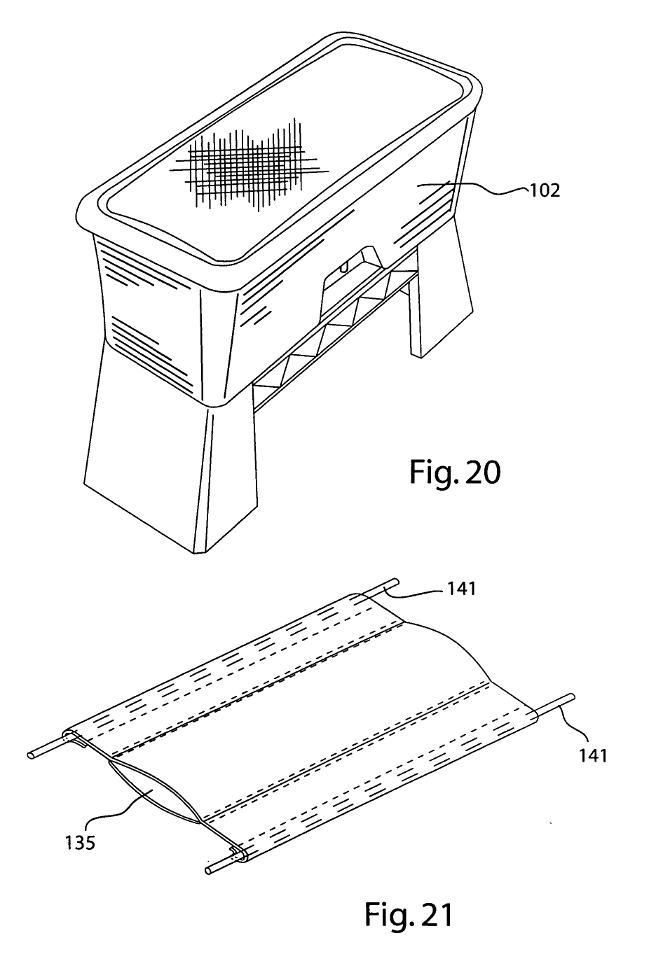

FIG. 19 is an isometric view diagrammatically depicting a growing container wherein cover sheet 134 is attached to the four corners of the growing container by means of clip means designated as elements 115. These clip means have downwardly directed pins that engage into vertically oriented holes formed in the upper edge area of the corners of the container. FIG. 19 also depicts a container 102 having a nipple 122 formed around the water overflow location so that the overflow may be conducted away to a position where the overflow water will not harm the supporting surface. For example, if EARTHBOX® container is being utilized on a table, then the overflow can be directed to a container situated elsewhere on the table or located away from the table at a lower level so that water overflowing from the self-watering planter will flow to an excess water container or be used on a lawn or for other gardening purposes.

FIG. 21 depicts still another embodiment of a cover sheet 134 which is provided with an impervious upper sheet and a pervious under sheet to form a substantially tubular opening 135 extending along the length of the cover sheet so that plant nutrient material may be inserted into the opening 135 and provided on the self-watering planter at the same time that the cover sheet 134 is attached to the upper portion of the planting container. Also see the discussion regarding FIG. 15 above in connection with linear wire elements 141. It should be apparent that many different arrangements of this embodiment may be designed wherein the plant nutrients are physically connected with the cover sheet for the growing container. It should be understood that the lower web of the cover sheet utilized in FIG. 21 is provided with a porous structure so that the plant nutrients can effectively pass through the structure to interact with moisture in the growing medium and the plants.

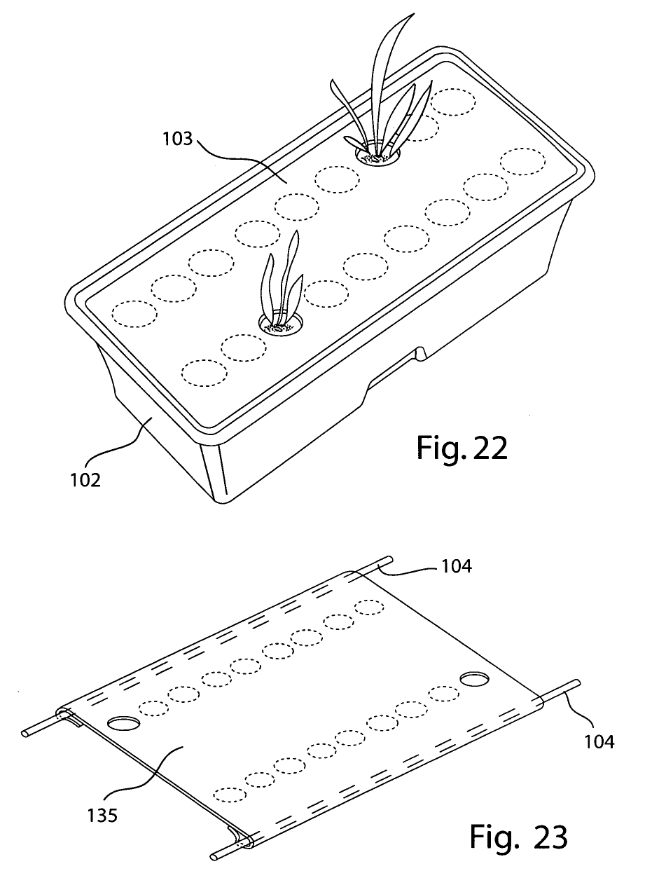

FIG. 22 schematically depicts a growing container utilizing a cover sheet 103 having indicia thereon to indicate areas for planting of a seedling or seeds. Thus, the linear arrangement of circular indicia are meant to depict perforations or other weakened areas of the cover sheet so that the gardener has specific structural guidance for the placement of seeds or seedlings.

FIG. 23 depicts a specific embodiment similar to the cover sheet depicted in FIG. 18, for example using linear side wires for attaching to the lateral sides of a planting container and perforated circular portions of the coversheet 135 which may be easily removed by tearing or punching by the gardener prior to placing the seeds or plants through the opening formed by the removal of the circular portion.

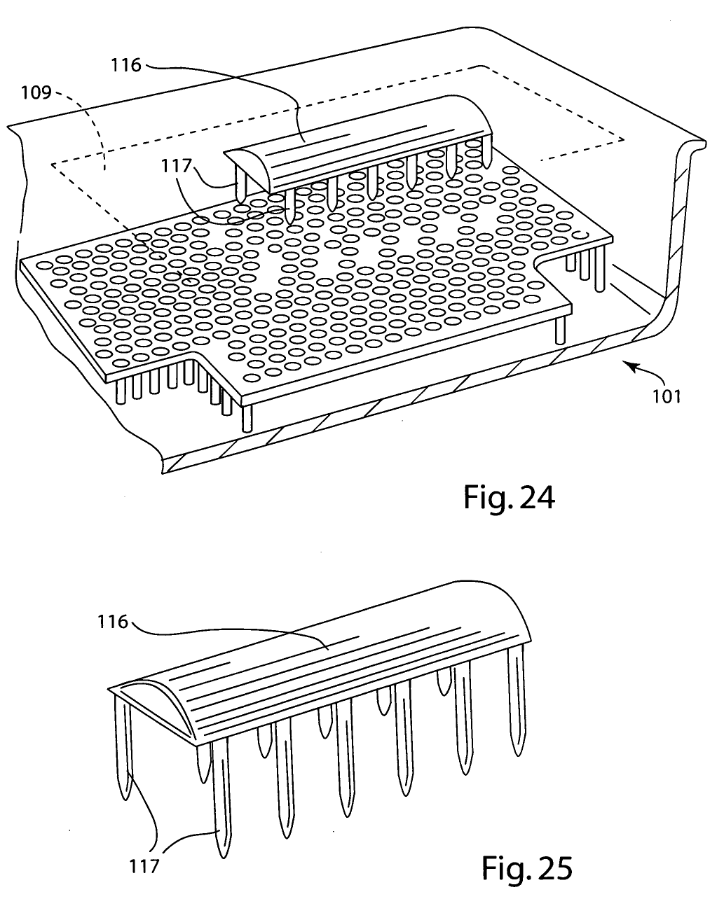

FIG. 24 depicts a self-watering planter 101 having a container 102 and a perforated wall 108 supported above the water-holding portion of the container. Moreover, it schematically depicts growing medium 109 filled within the upper portion of the growing container and a porous fertilizer holding container 116 which is situated along the lineal axis of the container on the surface of the growing medium. Downwardly projecting elements 117 are provided to securely position the element 116 in place so that the source of plant nutrients does not shift during usage of the planted container. It should be understood that a cover sheet such as depicted in FIG. 11 for example is applied over the plant nutrient-holding element 116 prior to planting the seeds or seedlings.

FIG. 25 is another embodiment of the porous container 6 for plant nutrients and it depicts downwardly extending elements 117 connected to the nutrient holding element for purposes of securely positioning the nutrient containing element on the top surface of the growing medium 109 such as depicted in FIG. 24.

While the present invention has been described with respect to exemplary embodiments thereof, it will be understood by those of ordinary skill in the art that variations and modifications can be effected within the scope and spirit of the invention.

We claim:

1. A planter for growing plants, said planter having a container with a bottom end and a surrounding wall member defining an open top, a perforated partition mounted to said wall member in a spaced relationship above said bottom end to define a water reservoir space below said partition, a growing medium spaced from above the partition toward the top of the container, a cover located near the top of said container: and at least one wire element engaged with an edge of said cover, the ends of said wire being engaged with said container.

2. The combination of claim 1 wherein said ends are configured and arranged to be inserted in respective holes defined in said container.

3. The combination of claim 2 wherein said wire elements extend along at least two respective edges of said cover.

4. The combination of claim 3 wherein said cover is rectangular in shape with a portion cut out in each of the four corners so that portions of the growing medium are exposed.

5. The combination of claim 4 further comprising at least one opening in said cover for insertion of a seedling or seeds into the growing medium.

6. The combination of claim 5, wherein said cover includes a circular array of perforations to facilitate removal of the enclosed circular material to form an opening for planting, evaporation, insertion of a water supply pipe, or allowing water to be provided into the growing medium.

7. A planter for growing plants, said planter having a container with a bottom end and a surrounding wall member defining an open top, a perforated partition mounted to said wall member in a spaced relationship above said bottom end to define a water reservoir space below said partition, a growing medium spaced from above the partition toward the top of the container, a cover located near the top of said container, said cover is a flexible sheet of material having anchoring means attached thereto for anchoring said sheet into said growing medium.

8. The combination of claim 7, wherein said anchoring means are wire elements with substantially vertical portions insertable into said growing medium.

9. The combination of claim 7, wherein said anchoring means is an elasticized periphery of said flexible sheet.

10. A planter for growing plants, said planter having a container with a bottom end and a surrounding wall member defining an open top, a perforated partition mounted to said wall member in a spaced relationship above said bottom end to define a water reservoir space below said partition, a growing medium spaced from above the partition toward the top of the container, a cover located near the top of said container, and means mounted on the upper edge of said wall member for clamping engagement with the edges of said cover.

11. The combination of claim 10, wherein said cover has at least one pre-cut opening of a sufficient size that a plant or seed can be planted therethrough.
